(19) United States
(12) Patent Application Publication
(10) Pub. No.: US 2003/0023458 A1
(43) Pub. Date: Jan. 30, 2003

(54) System and method for providing medical care via a virtual call center

(75) Inventors: John Haines, Lantana, FL (US); Michael Burrow, Grayson, GA (US); John Peifer, Atlanta, GA (US); Andrew Hopper, Tucker, GA (US); Stephen Ratzel, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Cyber-Care, Inc., Boyton Beach, FL (US)

(21) Appl. No.: 09/917,359

(22) Filed: Jul. 27, 2001

(51) Int. Cl. G06F 17/60

(52) U.S. Cl. 705/2

(57) ABSTRACT

A system and method for providing medical care to a patient via a virtual call center, regardless of the patient's location and a medical care agent's location, is disclosed. A patient digital processor allows a patient to provide a patient profile to the medical care system that is received by a medical care digital processor. A medical care agent digital processor allows a medical care agent to provide their characteristics to the medical care digital processor. Upon patient initiation, the medical care processor analyzes the patient profile to determine an appropriate medical care agent to address the patient's medical queries. A connection is then made between the patient digital processor and the medical care agent digital processor to allow “real time” interaction. Additional medical care agents may be added to the connection for additional medical analysis and input.

### FIELD OF THE INVENTION

The present invention generally relates to virtual networking and, more particularly, is related to a system and method for providing medical care to a patient seeking medical information via a virtual call center having intelligent call routing.

### BACKGROUND OF THE INVENTION

With the advancement of medical treatment methods and devices, medical care has become of vital importance in assuring maximum patient recovery. What was once a field characterized by the use of liquids and pills has advanced to a field characterized by the use of electronic devices and complicated mechanical devices.

Patient inquiries regarding medical treatment methods and devices are typically placed to a call center where trained medical care agents are physically located and may be questioned. A call director unit, which is capable of determining an appropriate medical care agent to receive an incoming call, typically receives an incoming call placed to the call center. The call director unit is capable of associating a patient's identification with a patient profile that may contain information regarding the current patient's prescription. This information may then be used to assist in assigning an appropriate trained medical care agent to answer patient questions. As an example, a patient profile may indicate that the patient is currently prescribed allergy medicine, after which a medical care agent familiar with such allergy medicines and possible side effects may be selected by the call director unit, to address patient concerns. In response, the medical care agent typically pulls pertinent information within the patient's profile prior to speaking with the patient.

Unfortunately, medical care agents that work for call centers typically work from a central call center location. However, in accordance with the job requirements of a medical care agent, it does not seem necessary for the medical care agent to work from any specific location. In fact, a medical care agent may be more effective if they could work from alternate locations, thereby making more efficient use of their time.

### SUMMARY OF THE INVENTION

The present invention provides a system and method for providing a patient with medical care via a medical care agent wherein both the medical care agent and the patient use of a virtual call center having intelligent call routing.

Generally, the system provides a patient with medical care regardless of the patient's location and a medical care agent's location. A patient digital processor allows a patient to provide a patient profile to the system that is received by a medical care digital processor. A medical care agent digital processor allows a medical care agent to provide their characteristics to the medical care digital processor. Upon patient initiation, the medical care processor analyzes the patient profile to determine an appropriate medical care agent to address the patient's medical queries. A connection is then made from the patient digital processor to the medical care agent digital processor to allow “real time” interaction.

The present invention can also be viewed as providing a method for providing a patient with a medical care agent, via use of a virtual call center having intelligent call routing. In this regard, the method can be broadly summarized by the following steps: creating a patient profile; characterizing a medical care agent; analyzing the patient's profile to find an appropriate medical care agent to address the question upon presentation of the patient to the medical care system; and, connecting the patient to the appropriate medical care agent regardless of where the patient and medical care agent are located.

The invention has numerous advantages, a few of which are delineated hereafter as examples. Note that the embodiments of the invention, which are described herein, possess one or more, but not necessarily all, of the advantages set out hereafter.

One advantage of the invention is that a medical care agent can communicate with a patient from any location.

Another advantage of the invention is that due to medical care agent availability no longer being limited to when the agent is physically located at a call center, the availability of medical care agents is potentially unlimited.

Another advantage is that the invention provides a method for care agents to be located anywhere and still be included in the call routing process as available resources.

Other features and advantages of the present invention will become apparent to one with skill in the art upon examination of the following drawings and detailed description. It is intended that all such additional features and advantages be included herein within the scope of the present invention, as defined by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating use of the medical care system within a typical Internet based system.

FIG. 2 is a block diagram that further illustrates the medical care digital processor of FIG. 1.

FIG. 3 is a flow chart that illustrates functionality performed by the medical care system of FIG. 1 to enable availability of a medical care agent.

FIG. 4 is a flow chart that illustrates functionality performed by the medical care system of FIG. 1 in providing a patient with medical care.

### DETAILED DESCRIPTION OF THE PREFERRED EMBODIMENT

The medical care system of the present invention can be implemented in software, firmware, hardware, or a combination thereof. In the preferred embodiment of the invention, which is intended to be a non-limiting example, the system is partially implemented in software and partially implemented in hardware. The software-portion of the system is executed by a computer, for example, but not limited to, a server, a personal computer, workstation, mini computer, or mainframe computer.

The software-based portion of the system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

Preferably, the medical care system of the present invention is implemented with use of the Internet. As such, a brief description and explanation of terms associated with the Internet follow. It should be noted that while the medical care system is implemented with use of the Internet, the system need not be provided via use of a Web browser, but instead, an alternate user interface may be used. Further, the medical care system may instead be implemented with use of an Intranet.

A browser, or “Web” browser, allows for simple graphical user interface (GUI) access to network servers, which support documents formatted as so-called Web pages. The World Wide Web (WWW), or “Web”, is a collection of servers on the Internet that utilize a Hypertext Transfer Protocol (HTTP), which is an application protocol that provides users access to files (which can be in different formats such as text, graphics, images, sound, video, etc.) using a Standard Generalized Markup Language (SGML), which is an information management standard for providing platform-independent and application-independent documents that retain formatting, indexing, and linking information. SGML provides a grammar-like mechanism for users to define the structure of their documents and the tags they will use to denote the structure in individual documents. The page description language known as Hypertext Markup Language (HTML) is an application of SGML. HTML provides basic document formatting of text and images and allows the developer to specify hyperlinks, or “links,” to other servers and files.

Use of an HTML-compliant client, such as a Web browser, involves specification of an address via a Uniform Resource Locator (URL). Upon such specification, the client makes a transmission control protocol/Internet protocol (TCP/IP) request to the server identified in the URL and receives a “Web page” (namely, a document formatted according to HTML) in return.

Electronic mail (e-mail) is another important part of online activity. Conventional e-mail is the exchange of text messages and computer files over a communications network, such as a local area network (LAN) or the Internet, usually between computers or terminals. Routing of email on the Internet is typically accomplished through the use of a protocol for sending messages called the simple mail transfer protocol (SMTP).

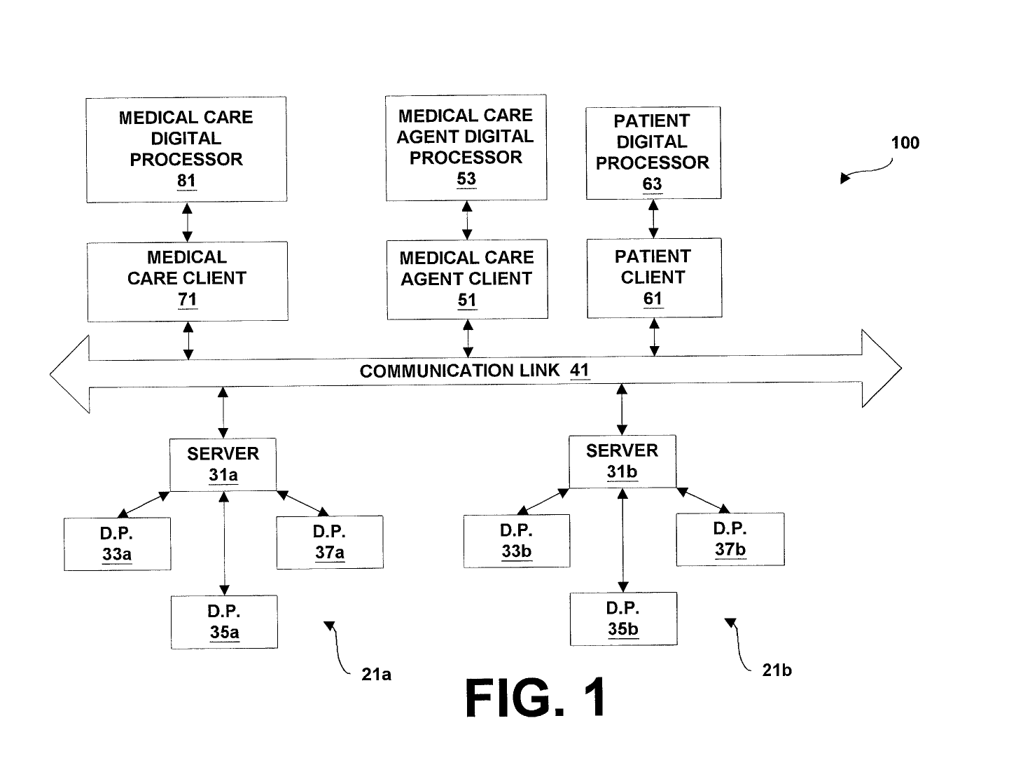

By way of example and illustration, FIG. 1 illustrates an Internet based system that may operate using a TCP/IP protocol, upon which the medical care system 100 of the present invention may be implemented. It should be noted that while the present disclosure provides implementation of the medical care system 100 within an Internet based system, the medical care system 100 need not be provided via use of the Internet. Instead, one of reasonable skill in the art will appreciate that the medical care system 100 may be implemented in connection with other mediums, such as, for example, but not limited to, a local area network (LAN), or wide area network (WAN). Further, in accordance with an alternative embodiment of the invention, the medical care system 100 may also utilize a multi-point control unit (MCU), wherein video conferencing systems located at several locations may be interconnected for conferencing between users, as described hereinbelow. The MCU provides for online consultation and referral capability among multiple caregivers. As known in the art, to initiate a conference using a MCU, a session host dials a number or makes some other appropriate connection such as a TCP/IP link, and then presents a conference identifier. The MCU then automatically sets up the conference and establishes TCP/IP connections to each user. Alternatively, users may then join the conference by dialing an access number to the MCU for instantaneous connection.

Referring to FIG. 1, a plurality of networks 21a, 21b are shown wherein each network 21 includes multiple digital processors 33, 35, 37. Digital processors 33, 35, 37 within each network 21 are or may include, but are not limited to, personal computers, mini computers, laptops, and the like. Each digital processor 33, 35, 37 is typically coupled to a host processor, or server 31a, 31b for communication among processors 33, 35, 37 within the specific corresponding network 21.

The host processor, or server, 31 is coupled to a communication link 41 that interconnects or links the networks 21a, 21b to each other, thereby forming an Internet. As such, each of the networks 21a, 21b are coupled along the communication link 41 to enable access from a digital processor 33a, 35a, 37a of one network 21a to a digital processor 33b, 35b, 37b of another network 21b.

Various end-user clients 51, 61, two of which are shown as an example, specifically, a medical care agent client 51 and a patient client 61, are linked to the communication link 41, thus providing a medical care agent and a patient with access to the Internet. A medical care agent digital processor 53 is coupled to the medical care agent client 51 for purposes of allowing a medical care agent to interact with patients via the Internet, as is further explained hereinbelow. Likewise, a patient digital processor 63 is coupled to the patient client 61 for purposes of allowing a patient to interact via the Internet, as is further explained hereinbelow.

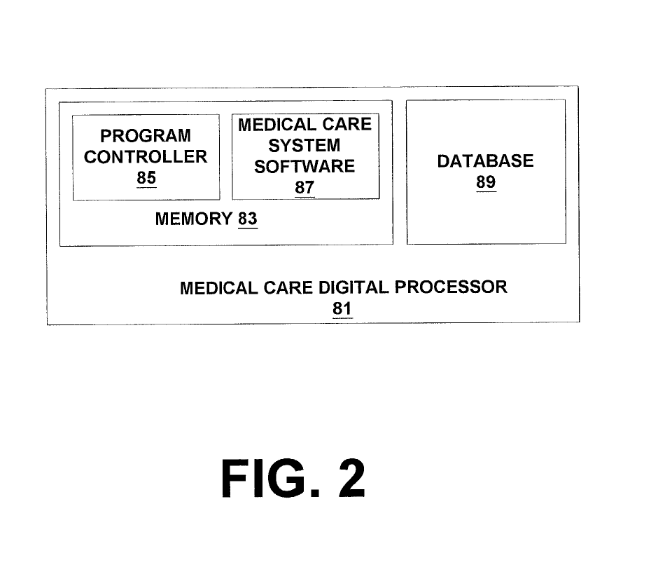

In accordance with the preferred embodiment of the invention, a medical care digital processor 81 is connected to the Internet via a medical care client 71. The medical care digital processor 81 stores both patient and medical care agent information, as described with reference to FIG. 2 hereinbelow. Logic for implementation of the medical care system 100 is provided by a software program located within the medical care digital processor 81, which is operated on and connected, via the medical care client 71, to the Internet for communication among the various networks 21a, 21b and/or digital processors 33, 35, 37 and other end-users connected to the Internet via respective end-user clients 51, 61. In accordance with the preferred embodiment of the invention, the medical care client 71 may run Windows NT or other platforms to support operation of the present medical care system 100. The networks used by the medical care system 100 may optionally be secure and encrypted for purposes of ensuring the confidentiality of information transmitted within and between the networks 21a, 21b.

FIG. 2 is a block diagram that further illustrates the medical care digital processor 81 of FIG. 1. It should be noted that the following structure of the medical care digital processor 81 is characteristic of the other digital processors 53, 63, 33, 35, 37 within the medical care system 100. As shown by FIG. 2, the medical care digital processor 81 comprises a memory 83 having a program controller 85 and medical care system software 87 stored therein. The program controller 85 is capable of performing functionality required by the medical care system 100, in addition to locating and updating data, as described in detail hereinbelow. The medical care digital processor 81 also comprises a medical care digital processor database 89 for storing patient and medical care agent information, as further described hereinbelow.

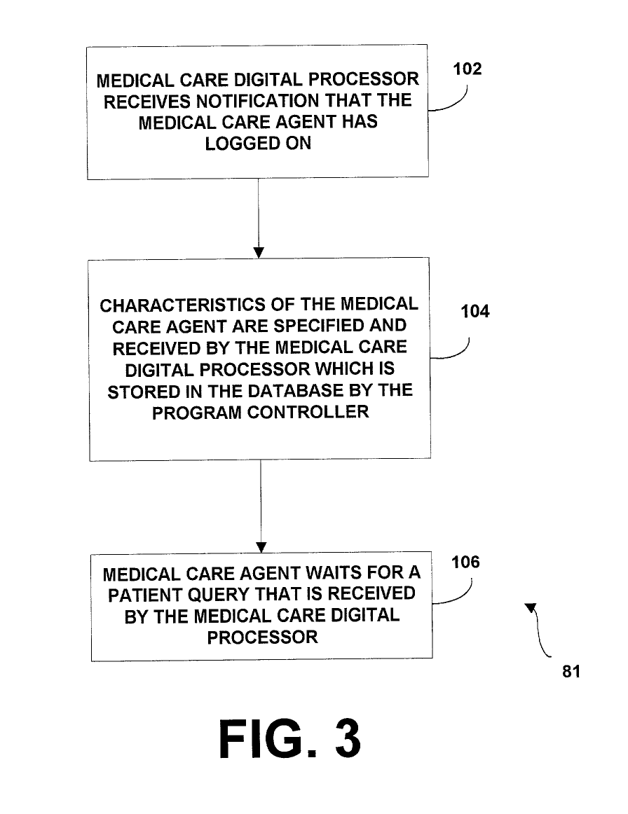

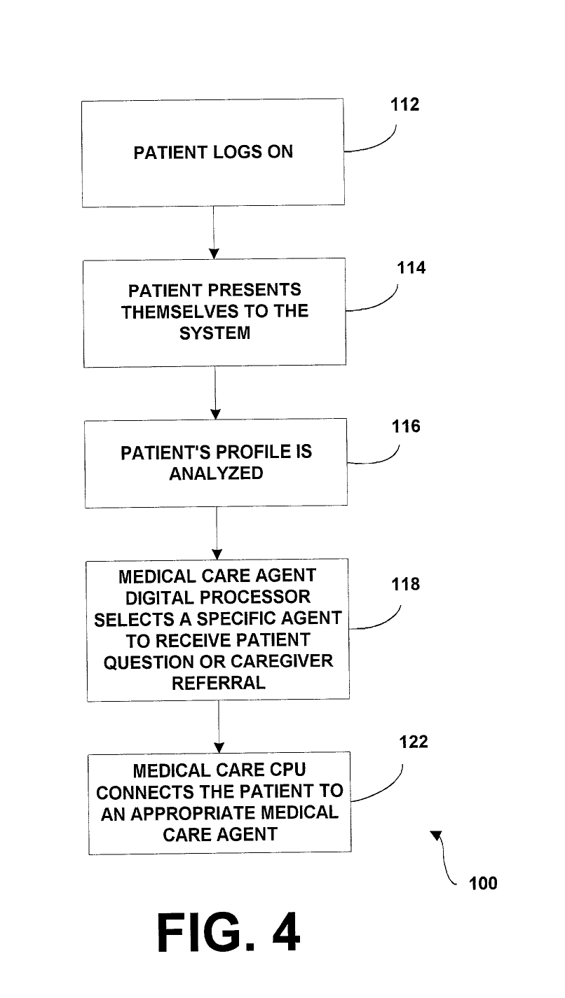

FIG. 3 is a flow chart that illustrates functionality performed by the present medical care system 100 to enable availability of a medical care agent. With regard to the flow charts of FIGS. 3 and 4, each block represents a module, segment, or portion of code, which comprises one or more executable instructions for implementing the specified logical function(s). In some alternate implementations, the functions noted in the blocks may occur out of the order noted. For example, two blocks shown in succession may in fact be executed in the reverse order, depending upon the functionality involved.

As shown by block 102, the medical care digital processor 81 receives notification that the medical care agent has logged onto the medical care system 100 via the medical care agent digital processor 53. It should also be noted that standard login procedures may be used by the present medical care system 100 to confirm identity of the medical care agent, and, therefore, such login procedures are not further discussed herein. In accordance with the preferred embodiment of the invention, the medical care system 100 is supported and maintained via the medical care digital processor 81, which defines functionality of the medical care system 100.

As shown by block 104, the characteristics of the medical care agent are then specified by the medical care agent via the medical care agent digital processor 53, and received by the medical care digital processor 81. Specification may, of course, be provided by someone besides the medical care agent. The characteristics of the medical care agent are, in turn, stored in the medical care digital processor database 89 by the program controller 85. Such characteristics may include, but are not limited to, area(s) of expertise, geographic coverage of their medical license, insurance company affiliation, etc. Preferably, the medical care agent's area(s) of expertise are directly related to the desired purpose of providing the medical care system 100. As an example, if the desired purpose of providing the medical care system 100 is to provide patient care for medical devices and prescriptions related to allergens, the medical care agent may specify whether they are a pharmacist or a doctor specializing in testing patients for allergies. The identification and area(s) of expertise of the medical care agent may be stored within the medical care database 89 for future use as described hereinbelow, with reference to FIG. 4. Preferably, the identification and area of expertise of the medical care agent are prestored in tabular form such that all medical care agents within a specific area of expertise may be quickly identified upon patient request.

An agent who has stored his characteristics in the database 89 may then log on to the medical care system 100 at any time and become an available resource. As shown by block 106, the medical care agent waits for a patient query to be transferred to him/her after the medical care digital processor 81 receives the query from the patient. As such, the medical care agent is placed on a holding period until the medical care system 100, via the medical care digital processor 81 contacts him/her with a patient query. A thorough explanation of how the medical care system 100 contacts the agent when the medical care digital processor 81 receives the patient query is provided with reference to FIG. 4. This holding period procedure is beneficial since a medical care agent may perform other functions while remaining available for a potential patient to contact them via the medical agent digital processor 53. As an example, call queuing may take place within the holding period, wherein a call waiting notice may be posted to the screen of a nurse who is meeting with another patient at the time of contact by the medical care system 100. The nurse may then either, take the call immediately, refuse the call, send a notice to the waiting caller stating that a response will happen momentarily, or may switch between callers by placing one on hold.

FIG. 4 is a flow chart that illustrates functionality performed by the present medical care system 100 in providing a patient with medical care. As shown by block 112, a patient first logs on to the medical care system 100 via the patient client 61, using the patient digital processor 63. As with reference to a medical care agent, standard log on procedures may be used by the present medical care system 100 to confirm identity of the patient, and therefore, such log on procedures are not discussed herein.

As shown by block 114, the patient may then present themselves to the system 100 via their digital processor 63. Presentation of a patient to the system 100 signifies that the patient has a medical question to ask. Different methods may be used to present the patient to the system 100. As an example, the TCP/IP address of a patient profile may be transmitted from the patient digital processor 63, via the patient client 61, to the medical care digital processor, where the TCP/IP address relates to a location within the medical care digital processor database 89. Alternatively, a patient profile may be stored within the patient digital processor 63 and transmitted to the medical care digital processor 81.

The patient's profile is then analyzed by the medical care memory 83, in order to associate a medical care agent within the patient's profile, whose characteristics are best suited to the needs of the patient, and who is also available (e.g., online) at the time of patient presentation. As described with reference to FIG. 3, the appropriate medical care agent area of expertise is correlated to a group of medical care agents. As shown by block 118, the medical care memory 83 then selects a specific medical care agent to receive the patient question or caregiver referral. Preferably, selection of a medical care agent is performed by determining which medical care agent has been logged onto the medical care system 100 for the longest period of time, without receiving a patient call. As shown by block 122, the medical care memory 83 then connects the patient to an appropriate medical care agent, via the medical care agent client 51 and digital processor 53.

After addressing a medical issue with a patient, a medical care agent may determine that a patient needs further medical analysis, or attention from a different medical care agent having more knowledge or experience within a specific medical area. In addition, a medical care agent may wish to receive a second opinion on a medical matter. Where the medical care agent wishes to receive a second opinion, the medical care agent may submit a request to the system 100, via their medical care agent digital processor 53, requesting the attendance of another medical care agent having the necessary medical expertise. As a result, a second medical care agent is connected with the first medical care agent and the patient, so that communication between all three parties is possible. Of course, more parties may be brought into the conference in accordance with the medical needs of the patient.

If, instead, a first medical care agent wishes for the patient to receive medical attention from a different medical care agent (a second medical care agent), the first medical care agent may submit a request to the system 100 for the second medical care agent. Specific reference to the second medical care agent may be performed by, for example, but not limited to, presenting the second agent's name within the request to the system 100. If the second medical care agent is available (e.g., online) the system 100 connects the identified second medical care agent with the first medical care agent and the patient. For purposes of illustration, an example of when a first medical care agent may request that a client receive medical attention from a second medical care agent is when the first agent has analyzed the client's medical condition and is prescribing a particular medication. When the second agent is connected to the first agent and the client, the first agent can inform the second agent, in this case a pharmacist, of a prescription that needs to be filled, after which the second agent may fill the prescription and send it to the patient.

In accordance with an alternate embodiment of the invention, the stored characteristics of the patient may be used to find the best matching characteristics of the online medical care agents such that an automatic caregiver best match is accomplished without patient data entry.

Preferably, the medical care agent digital processor 53 provides visual, textual, and vocal capabilities, such that the medical care agent may communicate with the patient via means similar to that used by the patient digital processor 63. It should also be noted that, like the medical care agent, the patient may interact with the present medical care system 100 from different locations, since the patient digital processor may be mobile, or the patient may have numerous digital processors at separate locations.

In accordance with a first alternative embodiment of the invention, a patient profile is maintained within the medical care digital processor database 89. Accordingly, when a patient logs onto the medical care system 100, which is maintained by the medical care digital processor 81, the patient is required to answer a series of questions directed toward determining potential medical devices, services and prescriptions which may require medical care at a future date. Otherwise, this may be entered on behalf of the patient by a caregiver. The accumulated patient information is then stored within a patient profile.

After the patient profile has been created, whenever a patient logs on to the medical care system 100, the medical care digital processor 81 automatically links the patient to an appropriate medical care agent that has the necessary expertise to answer the patient-provided question or, to address the medical conditions of the patient which have been previously determined by the patient's answers to the series of questions.

As an example, if the medical care system 100 is used for providing medical care to patients with heart problems, the medical care digital processor database 89 may store a patient's recent blood pressure, name, address and data regarding cardiograph readings. In response, when a patient logs onto the medical care system 100, the medical care digital processor 81 automatically routes all patient queries to an appropriate medical care agent digital processor 53, such that the best suited medical care agent responds to the patient's needs. It should be noted that the number of patients and medical care agents may differ in accordance with the purpose of the medical care system 100.

In accordance with a second alternate embodiment, medical care agents are not required to specify their area of expertise after logging into the medical care system 100. Instead, all medical care agent information regarding areas of expertise is predetermined and stored within the medical care digital processor database 89. Predetermination of a medical care agent's areas of expertise may be performed via e-mail, telephone, fax or any means of communication wherein the medical care agent can specify pertinent information to a medical care system representative. The medical care system representative then enters, and stores, information regarding each medical care agent's specific areas of expertise within the medical care digital processor database 89.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A system for providing medical care to a patient via a virtual call center, comprising:
at least one patient digital processor capable of receiving and transmitting video and data, wherein said at least one patient digital processor is controlled by at least one patient;
at least one medical care agent digital processor capable of receiving and transmitting video and data to said patient digital processor, wherein said medical care digital processor is controlled by at least one medical care agent;
at least one storage unit for storing information regarding said patient and characteristics of said medical care agent; and
a medical care digital processor capable of receiving a request for medical care from said patient via said patient digital processor, determining an appropriate medical care agent from said storage unit to address said request for medical care, and connecting said patient digital processor and said appropriate medical care agent, via said medical care agent digital processor, as a result of said determination.

2. The system of claim 1, wherein said connection allows live video and data transmission between said patient and said appropriate medical care agent.

3. The system of claim 1, wherein said medical care agent information is provided by said medical care agent and is directly related to a medical purpose of said system.

4. The system of claim 1, wherein said medical care agent provides said characteristics to said storage unit prior to said storage of said patient information within said storage unit.

5. The system of claim 1, wherein a series of medical care agents are provided by said system, and determination of said appropriate medical care agent is a reflection of the amount of time said appropriate medical care agent has been logged on to said system waiting to assist said patient.

6. The system of claim 1, wherein said system is provided within an Intranet.

7. The system of claim 1, wherein said determination of an appropriate medical care agent from said storage unit is performed by comparing said patient information to said characteristics of said medical care agent.

8. The system of claim 7, wherein said patient information is received by said medical care agent digital processor receiving a Transmission Control Protocol/Internet Protocol (TCP/IP) address of said patient information, within said storage unit, from said patient digital processor.

9. The system of claim 1, wherein said patient digital processor is a multi-point control unit and said medical care agent digital processor is a multi-point control unit.

10. The system of claim 1, wherein said medical care digital processor is capable of receiving a request for an additional medical care agent from said medical care agent digital processor, wherein a connection is then made between said patient digital processor, said appropriate medical care agent, and said additional medical care agent.

11. A system for providing medical care to a patient via a virtual call center, comprising:
at least one first means for receiving and transmitting video and data, wherein said first means is controlled by at least one patient;
at least one second means for receiving and transmitting video and data to said first means, wherein said second means is controlled by at least one medical care agent;
at least one means for storing information regarding said patient and characteristics of said medical care agent; and
a means for receiving a request for medical care from said patient via said first means, determining an appropriate medical care agent from said storing means to address said request for medical care, and providing a connection between said first means and said appropriate medical care agent, via said second means, as a result of said determination.

12. The system of claim 11, wherein said connection allows live video and data transmission between said patient and said appropriate medical care agent.

13. The system of claim 11, wherein said medical care agent information is provided by said medical care agent and is directly related to a medical purpose of said system.

14. The system of claim 11, wherein said medical care agent provides said characteristics to said means for storing prior to said storage of said patient information within said means for storing.

15. The system of claim 11, wherein a series of medical care agents are provided by said system, and determination of said appropriate medical care agent is a reflection of the amount of time said appropriate medical care agent has been logged on to said system waiting to assist said patient.

16. The system of claim 11, wherein said system is provided within an Intranet.

17. The system of claim 11, wherein said determination of an appropriate medical care agent from said means for storing is performed by comparing said patient information to said characteristics of said medical care agent.

18. The system of claim 17, wherein said patient information is received by said second means receiving a Transmission Control Protocol/Internet Protocol (TCP/IP) address of said patient information, within said means for storing, from said patient digital processor.

19. A method for providing medical care to a patient via a virtual call center, comprising the steps of:
creating a patient profile;
characterizing at least one medical care agent;
storing said patient profile and said characterization of said medical care agent;
upon receiving a request for medical care from said patient, analyzing said patient profile to locate an appropriate medical care agent to address said request; and
providing live interaction between said patient and said appropriate medical care agent, regardless of where the patient and medical care agent are located.

20. The method of claim 19, wherein said live interaction comprises video and data transmission.

21. The method of claim 19, wherein said method is provided via the Internet

22. The method of claim 19, wherein said step of characterizing said medical care agent is provided by said medical care agent and is directly related to a medical purpose of said method.

23. The method of claim 19, wherein a series of medical care agents are provided by said method, and said step of analyzing said patient profile to locate an appropriate medical care agent to address said request is a reflection of the amount of time said appropriate medical care agent has been logged on as available for said method to assist said patient.

24. The method of claim 19, wherein said method is provided within an Intranet.

25. The method of claim 19, further comprising the step of providing live interaction between said patient, said appropriate medical care agent and a second medical care agent upon receiving a request for medical care from said appropriate medical care agent.
